(19) United States
(12) Patent Application Publication
(10) Pub. No.: US 2006/0182062 A1
(43) Pub. Date: Aug. 17, 2006

(54) Method for inter-frequency handover

(75) Inventors: Vaia Sdralia, Staines (GB); Thierry Lestable, Staines (GB); Hokyu Choi, Staines (GB)

Correspondence Address: DILWORTH & BARRESE, LLP, 333 EARLE OVINGTON BLVD., UNIONDALE, NY, 11553, US

(73) Assignee: Samsung Electronics (UK) Limited, Surrey (GB)

(21) Appl. No.: 11/332,760

(22) Filed: Jan. 13, 2006

(30) Foreign Application Priority Data
Jan. 14, 2005 (GB) 0500761.2

(51) Int. Cl. H04Q 7/00

(52) U.S. Cl. 370/331

(57) ABSTRACT

A method of inter-frequency handover for when a user terminal moves from a first cell to a second cell. Each of the cells comprises an access point to a radio network, and the measurements for the handover are performed by the access point of the first cell.

### FIELD OF THE INVENTION

The present invention relates to a method of inter-frequency handover.

### BACKGROUND OF THE INVENTION

An example of a telecommunications network is the Universal Mobile Telecommunications Service (UMTS) which is a third generation broadband packet-based transmission service based on the Global System for Mobile (GSM) communication standard. Such a system is described in 3GPP TS 25.401 v 5.7.0 (December 2003) (Technical Specification Group Radio Access Network UTRAN overall description (release 5)), available from the Third Generation Partnership Project (3GPP™), at 650 Route des Lucioles, Sophia Antipolis, Valbonne, France, or their website at www.3gpp.org.

A UMTS network may be considered to consist of three elements interacting with one another, namely the core network, the radio access network and the user terminals (such as mobile phones). The core network provides switching, routing and traffic transit. The radio access network provides the air interface access method from the core network to the user terminals.

UMTS networks can operate in different modes; eg time division duplex (TDD) and frequency division duplex (FDD). The network architecture comprises a series of base stations, or access points, that are commonly referred to as node Bs. The control equipment for the node-B's is termed the Radio Network Controller (RNC). The access point is responsible for the radio link, or connection, to the user terminals. The access point's area of responsibility is determined by the radio coverage achieved by the access point. This area is generally termed a cell.

FIG. 1 shows an example of a series of cells. An access point is located in the centre of each of the cells.

When a user terminal, such as a mobile phone, is moved from one cell to another a handover of the communication link between the access point in the cell the user is moving from and the access point in the cell the user is moving to must be made. Similarly, where two systems provide overlapping coverage, a user may be handed over from one system to another. A handover that requires a change of the carrier frequency is termed an inter-frequency handover. With an inter-frequency handover usually existing radio links with the user terminal are broken before new radio links with the new access point are established.

The specific type of handover depends upon the radio network and the operational mode in use. Handovers may be categorised as the following:

An intra-system handover is the switching process within the same radio access network;

An inter-system handover is the switching process between different radio access systems (such as UMTS to WLAN, or GSM to UMTS);

An intramode handover is the switching process between two cells of the same operation mode within the same radio access network;

An intermode handover is the switching process between two cells of different operational modes within the same radio access network.

In the example shown in FIG. 1, assume that cell 1 is operating in UMTS FDD mode, and that cell 2 is operating in UMTS TDD mode, and that a user terminal moves from cell 1 to cell 2. In this case an intermode handover is required because the radio access system is the same (UMTS), but the operational mode is different (FDD compared with TDD).

Typically a mobile phone only comprises one receiver. Thus it cannot receive data from two different modes simultaneously. Thus if the user terminal moves from cell 1 to cell 2 it cannot simultaneously operate in FDD mode in cell one and make measurements on the TDD operational mode of cell 2.

In current arrangements during intermode handovers the user terminals are allocated time to make the necessary measurements on the different operational mode in the cell to which they are moving. In order to achieve this time each of the user terminals operates in what is termed compressed mode. This can be implemented in three different methods. These are: reducing the spreading factor by 2:1 and therefore increasing the data rate so the data bits will get sent twice as fast; removing various bits from the original data (termed puncturing) so that the amount of information to be sent is reduced; and, using higher layer scheduling in order to allocate fewer timeslots for user traffic.

Thus, in the time made available by the compressed mode, the user terminal switches between receiving modes to allow it to makes measurements on the operational mode in the next cell.

A problem with the existing arrangement is that because each mobile terminal must performed a compressed mode operation during a handover the basic operation of the user terminal is compromised during handover.

The present invention seeks to improve the current situation.

### SUMMARY OF THE INVENTION

According to the present invention there is provided a method of inter-frequency handover when a user terminal moves from a first cell to a second cell, each of said cells comprising an access point, wherein the measurements for the handover are performed by the access point of the first cell.

The present the present invention preferably applies to a handover process between modes of the same system, or between different systems where the frequency used is different—i.e. to inter-frequency handovers. The present arrangement provides for less disruption of user terminal operation by eliminating the need for each of the user terminals to make measurements on the next cell prior to handover, and thereby eliminating the need for the user terminal to perform a compressed mode operation. The result of the arrangement is a faster handover, and, because the user terminal is not required to perform its own frequency measurements, a more efficient handover as the user terminal has more time to prepare its physical layer configuration (coding scheme) for link adaptation.

The second cell may completely encompass the first cell. It is particularly preferred that the first cell comprises a short range mode, and the second cell comprises a wide range mode. Preferably the first cell comprises a diameter of 10 m to 50 m.

Preferably the handover is an intermode handover. In a particularly preferred arrangement the access point performs the measurements for intermode, intra system and intersystem handovers, and the user terminal performs its own measurements for intramode handovers.

In a preferred arrangement the access point of the first cell periodically measures the operational mode in adjoining cells and transmits them to the user terminals within the first cell. In an equally preferred embodiment the access point in the first cell transmits measurements on the second cell after a trigger request.

### BRIEF DESCRIPTION OF THE DRAWINGS

In order that the present invention maybe more readily understood, specific embodiments thereof will now be described with reference to the accompanying drawings, in which:

FIG. 1 shows an example of a plurality of cells within a radio access network.

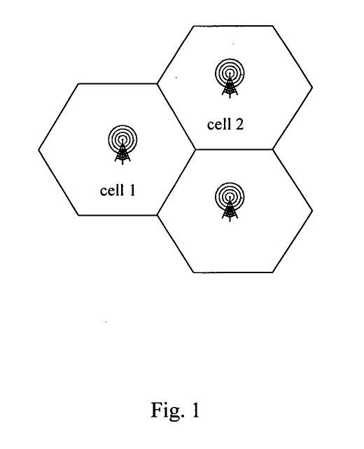

FIG. 2 shows a diagramatic example of a UMTS mobile telecommunications system.

FIG. 3 shows a specific embodiment of the present invention wherein a plurality of smaller cells are contained within a larger cell.

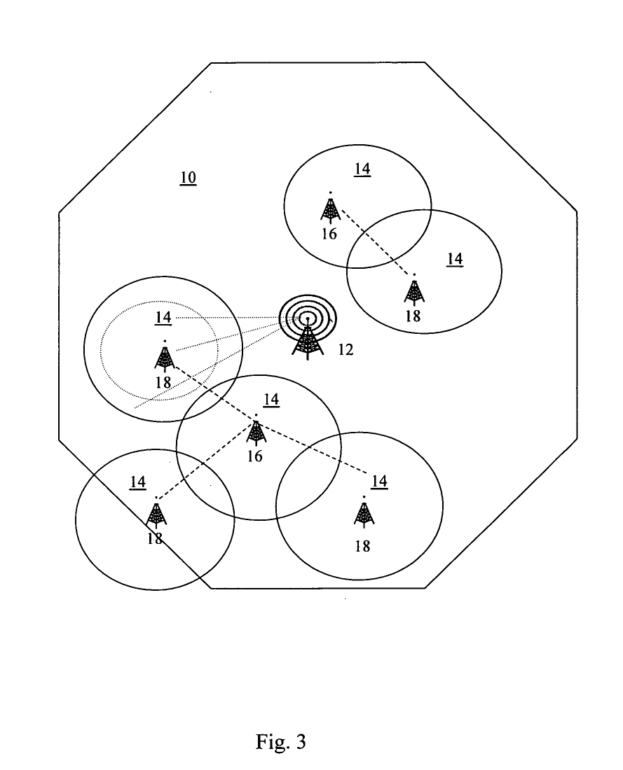

FIG. 4 is a flow chart describing a possible intermode handover in accordance with the present invention.

FIG. 5 is a diagram showing the positioning of a wide range access point, a short range access point and a user terminal.

### DETAILED DESCRIPTION

A communication system such as a mobile telecommunications system comprises a plurality of user terminals, such as mobile phones, in radio communication with a base station referred to hereafter as a Node-B, provided within a cell.

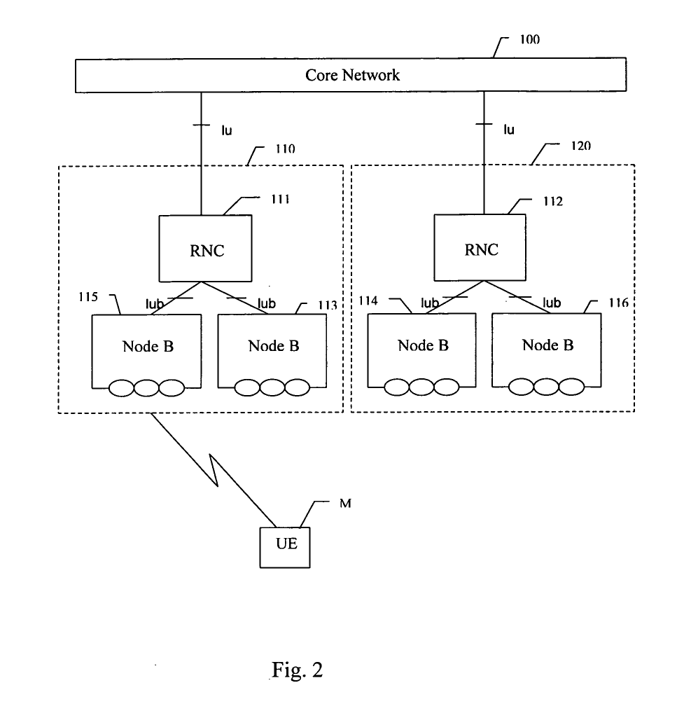

FIG. 2 is a diagram schematically illustrating a structure of a conventional UMTS communication system. The UMTS communication system comprises a core network (CN) 100, a plurality of radio network subsystems (RNSs) 110 and 120, and a user terminal M. Each of the RNSs 110 and 120 comprise a radio network controller (RNC) and a plurality of Node-Bs (each handling a cell). More specifically, the RNS 110 comprises an RNC 111 and a plurality of Node-Bs 113 and 115, and the RNS 120 comprises an RNC 112 and a plurality of Node-Bs 114 and 116. The RNCs are classified as either a Serving RNC (SRNC), a Drift RNC (DRNC), or a Controlling RNC (CRNC), according to their functions. The SRNC and the DRNC are classified according to their functions for each user terminal. An RNC that manages information on a user terminal and controls data exchange with a core network is an SRNC, and when data of a user terminal is transmitted to the SRNC, not directly but via a specific RNC, the specific RNC is called a DRNC of the user terminal.

The CRNC represents an RNC controlling each of Node-Bs. For example; in FIG. 2, if the RNC 111 manages information on the user terminal M, it serves as an SRNC of the user terminal M, and if data of the user terminal M is transmitted via the RNC 112, due to movement of the user terminal M, the RNC 112 becomes a DRNC of the user terminal M. The RNC 111 controlling the Node-B 113 becomes a CRNC of the Node-B 113.

The core network includes, for example, an Internet Protocol (IP) backbone network or other packet network, and/or a circuit switched (standard telephony) network. It will not further be discussed since it is of conventional type.

Each Node-B comprises a radio transmitter apparatus and a radio receiver apparatus, operating under the control of a control system comprising one or more programmable computers, so that it can send data to and receive data from the user terminals on the data downlink and data uplink respectively, and to and from the RNC. It can also control some aspects of the communications links within its cell, and to this end it can send signalling data to and receive signalling data from the user terminals on the signal downlink and signal uplink respectively.

Each user terminal comprises a radio transmitter apparatus and a radio receiver apparatus, operating under the control of a control circuit, together with a battery and/or other power supply, a user interface including input and output devices, and an output port for connection to other devices (such as a computer).

As these aspects of the equipment are conventional, well known to the reader, and unnecessary for an understanding of the present invention, further details are omitted herein.

The embodiment described below relates to a system with a wide range cell 10, with an access point 12 located therein. Several short range cells 14 are disposed within the wide range cell 10. Each of the short range cells 14 include either an access point 16 or a relay node 18. The short range modes are typically characterised by a high cell throughput of up to 1 Gbps for indoor and outdoor connectivity at low user terminal mobility either through single cell, single hop network topologies or multi-hop structures. The data rates for the wide range cell are typically 100 Mbps for medium to high user terminal mobility.

The wide range cell 10 exists as an umbrella over the short range cells 14 and provides continuous coverage for users with high mobility. The short range cells 14 are operable to provide coverage in areas such as buildings and public places, and would typically have a cell diameter of 10 m to 50 m.

The present embodiment relates to an intermode handover when a user terminal M moves from a short range cell 14 to the wide range cell 10. However, it will be appreciated that the present invention can be applied to any inter-frequency handover.

During known inter-frequency handover the user terminals are allocated time to make the required measurements on the different carrier frequencies in the next cell. This is achieved by switching to a compressed mode.

However, in the present arrangement the access point 16 or relay node 18 of the short range cell 14 in which the user terminal is moving from performs the measurements concerning the operation of the wide range cell 10. The access point 16 or relay node 18 in the short range cell then transmits the information to all user terminals on a specific channel. The transmission may be on a periodic basis, or based on a trigger, such as a specific request from a user terminal.

The present method is particularly applicable for user terminals that are within a certain radius of the access point 16 or relay node 18 of the short range cell 14 from which it is leaving. This is because the approximation accuracy of the method relies on the ratio of the cell size between the wide range cell 10 and the short range cell 14. The size of the certain radius mentioned above will depend upon a number of factors, including the specifics of the air interface used and the accuracy of the measurements made by the access point 16 or relay node 18. If the user terminal is outside the certain radius it may use standard techniques. Thus, in the short range cell 14, user terminals within the certain radius were the path loss from the user terminal to the base station 12 can be approximated to the path loss from the access point 16 to the base station 12 may rely on the access point to supply measurements on inter-frequency handovers. User terminals outside the certain radius may perform compressed operations, and make their own measurements on the wide range cell 10.

Thus, in the present embodiment, the access point 16 will be able, due to the small size of the short range cell, to estimate the measurements for the wide range cell 10. These measurements can then be transmitted to each of the user terminals within an area where the measurement accuracy is sufficiently high. A mathematical analysis of the above is set out below.

In a particularly preferred arrangement the access point 16 or relay node 18 is operable to estimate the environment conditions within its cell, and hence estimate the wide range cell parameters for each specific user terminal based on user terminal measurements for the short range cell. This arrangement may be achieved with multi-directional antennas, whereby the short range cell 14 is divided into notional sectors. In this arrangement the access point 16 or relay node 18 periodically requests some or all of the idle user terminals M in the cell to perform wide area measurements and signal back, and thus create a sample of the environment and then link the characteristics of every sector in relation to the wide area cell. Thus a more complete overview of the wide range cell 10 is achieved than by just using one estimate of the measurement for the short range cell 14 as a whole.

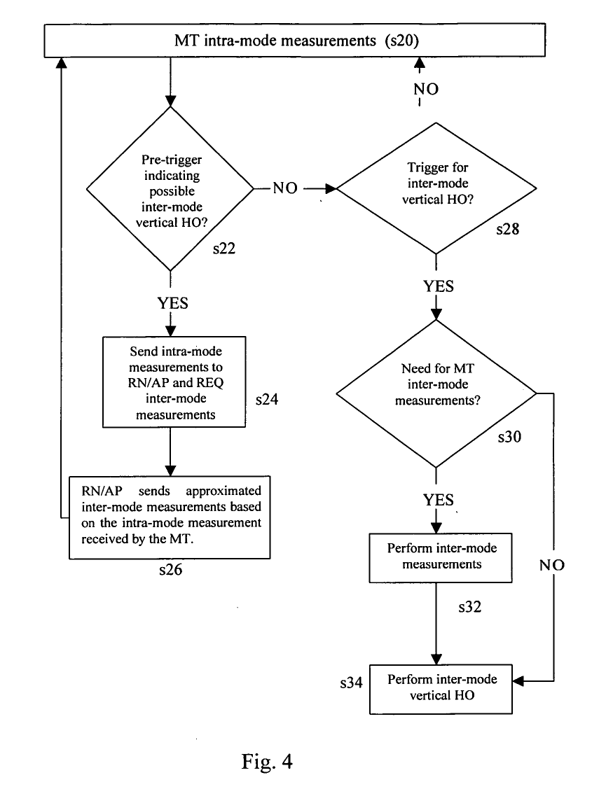

FIG. 4 is a flow diagram showing an embodiment of the present invention. In particular, as the user terminal makes periodic intramode measurements, two sets of triggers are activated. The first trigger is responsible for requesting update measurements and/or information on surrounding cells and networks from the access point 16 or relay node 18. The second trigger activates the handover process.

At step 20 the mobile terminal M performs intramode measurements on the short range cell 14. If the user terminal receives an indication (or pre-trigger) of a possible intermode handover, the user terminal, at step 24, sends the intramode measurements to the access point 16 or relay node 18 and requests intermode measurements.

At step 26 the access point 16 transmits approximated intermode measurements to the user terminals in the short range cell 14, based on the intramode measurements taken by the user terminal.

If the user terminal receives a trigger for an intermode handover (step 28) the user terminal accesses whether it has sufficient measurements to make the handover. If the user terminal M does have sufficient information to make the handover it will, at step 34, do so. If the user terminal does not have sufficient measurements the terminal, at step 32, performs its own measurements in the usual manner.

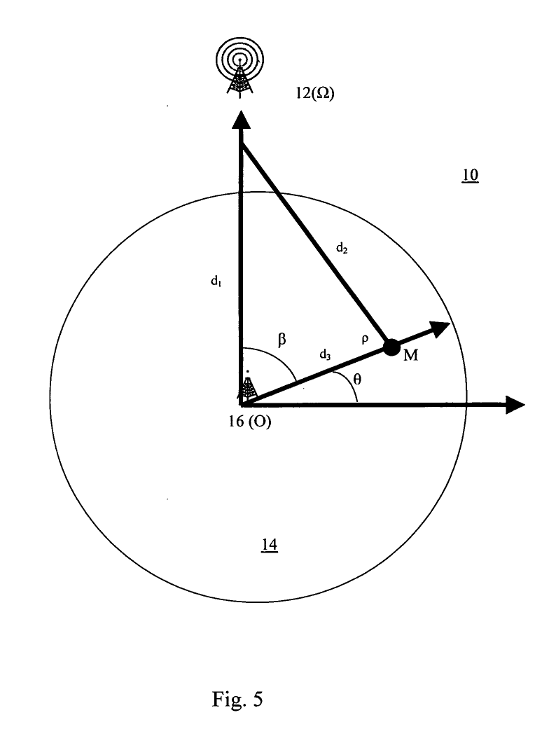

FIG. 5 shows an example of a short range cell 14, with an access point 16 located therein. A wide range access point 12 (also designated as Ω) is located outside the short range cell 14 (also designated as O). A user terminal M is located within the short range cell 14.

Using geometrical relationships, the distances between the wide range access point 12 and the user terminal M (d₂), the wide range access point 12 and the short range access point 16 (d₁), and the user terminal M and the short range access point 16 (d₃), by the following relationship:
d₂²==d₁²+d₃²−2·d₁·d₃·cos(β) (1)
where β=arg (OΩ, OM), the angle between the lines from the short range access point Ω to the wide range access point 0 and the short range access point Ω and the user terminal, and d₃=ρ, the mobile range.

However, as β=π/2−θ, Equation (1) can be re-written:
d₂²=d₁²+ρ²−2·d₁·ρ·sin(θ) (2)

For the Path-Loss expressions respectively for wide and short range cells, the known free-space propagation path loss (PL) formula set out below may be used:
PL=32.4+20·log(f)+20·log(d) (3)
where f represents the carrier frequency, and d is the path distance between two radio entities. Since the frequency for the system will be the same between the user terminal and the base station 12 and the access point 16 and the base station 12, the second term in the path loss equation is the same for both measurements. Thus the difference in the path loss between the base station 12 and the user terminal M and the base station 12 and the short range access point relates to the path distance between the two radio entities.

The following analysis demonstrates the feasibility of approximating a given Path Loss measurement [User Terminal (UT)/Wide range access point (WAP)] by mean of a neighbouring location Path Loss [short range access point (SAP)/wide range access point (WAP)].

The initial analysis, for simplicity, ignores Shadowing. In all cases, as the carrier frequency used is always for radio transmission and would be the same, the approximation accuracy is relying at least on the distance approximation.

Therefore an evaluation of a ‘confidence interval’, while using the distance [SAP/WAP] instead of directly [UT/WAP] is made.

Due to the short range cell 14 being embedded within the wide-range cell 10, and in view of a comparison of their distance with respect to the wide range access point 12 the user terminals are approximated to be within vicinity of the short range access point 16. In view of the fore going the accuracy approximation, or relevancy, of the scheme can be defined as:

$$η = 20 \cdot log [ \frac{{ⅆ}_{Ω M}}{{ⅆ}_{O Ω}} ] = 10 \cdot log [ \frac{{ⅆ}_{Ω M}^{2}}{{ⅆ}_{O Ω}^{2}} ] = 10 \cdot log [ \overline{η} ] \qquad ( 4 )$$

that means \overline{η}=10^{η/10}, which is the average approximation accuracy of the scheme.

By re-using Equation (2):

$${d}_{Ω M}^{2} = {d}_{O Ω}^{2} \cdot [ 1 + \frac{{ρ}^{2}}{{d}_{O Ω}^{2}} - 2 \cdot \frac{ρ}{{d}_{O Ω}} \cdot Sin θ ] \\ Thus \overline{η} = \frac{{ⅆ}_{Ω M}^{2}}{{ⅆ}_{O Ω}^{2}} = 1 + \frac{{ρ}^{2}}{{d}_{O Ω}^{2}} - 2 \cdot \frac{ρ}{{d}_{O Ω}} \cdot Sin θ \qquad ( 5 )$$

with (ρ, θ) Uniformly distributed respectively between [0,r]×[0,2π].

By (MATLAB) simulation, the average efficiency by marginalizing with respect to those two uniform distribution among the short range cell 14 can be analytically obtained: [symbol]
\overline{η} [symbol] =E{\overline{η}}=∫∫\overline{η}(ρ,θ)·p(ρ,θ)·dρ·dθ (6)

The Ergodism property allows for comparison between the set averaging with a proposed analytical expression.

Relying on both the independence and uniform distribution properties, the following mean expression can be obtained:

$$〈 \overline{η} 〉 = \int \int \overline{η} ( ρ , θ ) \cdot p ( ρ , θ ) \cdot ⅆ ρ \cdot ⅆ θ$$

$$〈 \overline{η} 〉 = \int \int [ 1 + \frac{{ρ}^{2}}{{d}_{O Ω}^{2}} - 2 \cdot \frac{ρ}{{d}_{O Ω}} \cdot Sin θ ] \cdot p ( ρ ) \cdot p ( θ ) \cdot ⅆ ρ \cdot ⅆ θ$$

with

$$p ( ρ ) = \frac{1}{r} , and p ( θ ) = \frac{1}{2 π} ,$$

where r is the short range cell radius.

Thus the following expression is obtained:

$$〈 \overline{η} 〉 = 1 + \frac{1}{3} \cdot {( \frac{r}{{d}_{O Ω}} )}^{2} \qquad ( 7 )$$

Therefore the efficiency function depends on the distance between the short range access point 14 and the wide range access point 12 d_{OΩ}.

Therefore, again, estimating an asymptotic expression while varying the distance between the short range cell access point 14 and the wide range cell access point 16 assume a uniform distribution for the distance profile, between Rₘᵢₙ and R_{wide}.

By integrating the previous relation

$${η}_{final} = \int 〈 \overline{η} 〉 \cdot p ( {d}_{O Ω} ) \cdot \partial {ⅆ}_{O Ω} \\ with p ( {d}_{O Ω} ) = \frac{1}{{R}_{wide} - {R}_{min}}$$

then, this leads to:

$${η}_{final} = 1 + \frac{{r}_{short}^{2}}{3} \cdot \frac{1}{( {R}_{wide} - {R}_{min} )} \cdot {\int }_{{R}_{min}}^{{R}_{wide}} \frac{ⅆ x}{{x}^{2}}$$

Finally:

$${η}_{final} = 1 + \frac{1}{3} \cdot \frac{{r}_{short}^{2}}{{R}_{min} \cdot {R}_{wide}} \qquad ( 8 )$$

introducing further notations:
Assume rₛₕₒᵣₜ=r₁·R_{wide}, and Rₘᵢₙ=r₂·R_{wide},

Then Equation (8) can be re-written as the following:

$${η}_{final} = 1 + \frac{1}{3} \cdot \frac{{r}_{1}^{2}}{{r}_{2}} \qquad ( 9 )$$

Now, an analysis of the domain of interest in terms of these two parameters, representing respectively the ratio between short range Radius and Wide Range Radius, together with the ratio between minimum distance between the short range cell access point 14 and the wide range cell access point 12 normalized by the Wide Range radius can be obtained.

It is to be appreciated that the above described specific embodiments are described by way of reference only, and that many different modifications and variations are possible within the scope of the accompanying claims.

What is claimed is:

1. A method of inter-frequency handover when a user terminal moves from a first cell to a second cell, each of said cells comprising an access point, wherein the measurements for the handover are performed by the access point of the first cell.

2. A method according to claim 1, wherein the second cell completely encompasses the first cell.

3. A method according to claim 1, wherein the first cell comprises a short range mode, and the second cell comprises a wide range mode.

4. A method according to claim 1, wherein the handover is an intermode handover.

5. A method according to claim 1, wherein the access point of the first cell performs the measurements for intermode, intra system and intersystem handovers, and the user terminal performs its own measurements for intramode handovers.

6. A method according to claim 3, wherein the access point of the first cell performs the measurements for intermode, intra system and intersystem handovers, and the user terminal performs its own measurements for intramode handovers.

7. A method according to claim 1, wherein the access point of the first cell periodically measures the operational mode in adjoining cells and transmits them to the user terminals within the first cell.

8. A method according to claim 3, wherein the access point of the first cell periodically measures the operational mode in adjoining cells and transmits them to the user terminals within the first cell.

9. A method according to claim 5, wherein the access point of the first cell periodically measures the operational mode in adjoining cells and transmits them to the user terminals within the first cell.

10. A method according to claim 1, wherein the access point in the first cell transmits measurements on the second cell after a trigger request.

11. A method according to claim 1, wherein if the user terminal is not able to receive measurements from the access point it performs its own measurements for the handover.

12. A telecommunications system comprising at least two cells, each cell comprising an access point, wherein when a user terminal moves from a first cell to a second cell the access point of the first cell performs measurements to allow handover of a call from the first access point to the second access point.
